(19) United States
(12) Patent Application Publication
(10) Pub. No.: US 2002/0065649 A1
(43) Pub. Date: May 30, 2002

(54) Mel-frequency linear prediction speech recognition apparatus and method

(76) Inventor: Yoon Kim, San Jose, CA (US)

Correspondence Address: BAKER & McKENZIE, 101 West Broadway, 12th Floor, San Diego, CA, 92101, US

(21) Appl. No.: 09/929,944

(22) Filed: Aug. 15, 2001

(30) Foreign Application Priority Data
Aug. 25, 2000 (TW) 89117296

(51) Int. Cl. G10L 19/10; G10L 19/08; G10L 19/04

(52) U.S. Cl. 704/219

(57) ABSTRACT

The present invention is an apparatus and method for generating parametric representation of input speech based on a mel-frequency warping of the vocal tract spectrum which is computationally efficient and provides increased recognition accuracy over conventional LP cepstrum approaches. It is capable of rapid processing operable in many different devices. The invention is a speech recognition system comprising linear prediction (LP) signal processor and a mel-frequency linear prediction (MFLP) generator for mel-frequency warping the LP parameters to generate MFLP parametric representations for robust, perceptually modeled speech recognition requiring minimal computation and storage.

### FIELD OF THE INVENTION

This invention relates generally to speech recognition systems and more particularly to speech spectrum feature extraction utilizing mel-frequency linear prediction.

### BACKGROUND OF THE INVENTION

Among the approaches to speech recognition by machine is for the machine to attempt to decode a speech signal waveform based on the observed acoustical features of the signal and the known relation between acoustic features and phonetic sounds. Choosing a feature that captures the essential linguistic properties of the speech while suppressing other acoustic aspects determines the accuracy of the recognition. The machine can only process what is extracted from raw speech, so if the chosen features are not representative of the actual speech, accurate machine speech recognition will be impossible. Further, information once lost at the feature extraction stage is lost forever. Therefore correct feature extraction is essential to accurate machine speech recognition. Typical automatic speech recognition systems sample points for a discrete Fourier transform calculation or filter bank, or other means of determining the amplitudes of the component waves of speech signal. For example, the parameterization of speech waveforms generated by a microphone is based upon the fact that any wave can be represented by a combination of simple sine and cosine waves; the combination of waves being given most elegantly by the Inverse Fourier Transform:

g(t)=1/2π∫_{-∞}^{∞}G(t)e^{i2πft}df

where the Fourier Coefficients are given by the Fourier Transform:

$$G ( f ) = {\int }_{- ∞}^{∞} g ( t ) {e}^{- i2π ft } ⅆ t$$

which gives the relative strengths of the components of the wave at a frequency f, the spectrum of the wave in frequency space. Since a vector also has components which can be represented by sine and cosine functions, a speech signal can also be described by a spectrum vector. For actual calculations, the discrete Fourier transform can be used:

$$G ( \frac{n}{τ N} ) = {\sum }_{k = 0}^{N - 1} [ τ \cdot g ( k τ ) {e}^{- i2π k \frac{n}{N}} ]$$

where k is the placing order of each sample value taken, is the interval between values read, and N is the total number of values read (the sample size). Computational efficiency is achieved by utilizing the fast Fourier transform (FFT) which performs the discrete Fourier transform calculations using a series of shortcuts based on the circularity of trigonometric functions.

Conventional speech recognition systems have parameterized the acoustic features utilizing the cepstrum, c(n), a set of cepstral coefficients, of a discrete-time signal s(n) which is defined as the inverse discrete-time Fourier transform (DTFT) of the log spectrum

$$c ( n ) = \frac{1}{2 π} {\int }_{- π}^{π} log [ S ( {ⅇ}^{i ω} ) ] {ⅇ}^{i ω n} ⅆ ω$$

Fast Fourier transform and linear prediction (LP) spectral analysis have been used to derive the cepstral coefficients. In addition, the perceptual aspect of speech features has been conveyed by warping the spectrum in frequency to resemble a human auditory spectrum. Thus typical speech recognition systems utilize cepstral coefficients obtained by integrating the outputs of a frequency-warped FFT filterbank to model non-uniform resolving properties of human hearing. An example is the mel cepstrum, which is a filterbank that has bandwidths resembling the critical bands of hearing. The center frequencies of the filterbank are non-uniformly spaced in accordance with the mel scale, a logarithmic-like scale of perceived pitch versus linear frequency; that is, a mel-scale adjustment translates physical Hertz frequency to a perceptual frequency scale and is used to describe human subjective pitch sensation. The cepstrum is then obtained by taking the inverse DTFT of the log amplitudes of the filterbank outputs.

Linear prediction (LP) performs spectral analysis on frames of speech with a so-called all-pole modeling constraint. That is, a spectral representation typically given by Xₙ(eⁱ) is constrained to be of the form /A(eⁱ), where A(eⁱ) is a p^{th} order polynomial with z-transform given by

A(z)=1+a₁z⁻¹+a₂z⁻²+. . . +aₚz^{-p}

The output of the LP spectral analysis block is a vector of coefficients (LP parameters) that parametrically specify the spectrum of an all-pole model that best matches the signal spectrum over the period of time of the sample frame of the speech. The conventional LP cepstrum is derived from the LP parameters a(n) using the recursion relation

c(0)=1nG²

$$c ( n ) = a ( n ) + \frac{1}{n} {\sum }_{k = 1}^{n - 1} kc ( k ) a ( n - k )$$

where n>0. Conventional speech recognition systems typically utilize LP with an all-pole modeling constraint.

The Perceptual Linear Prediction (PLP) method also utilizes a filterbank similar to the mel filterbank to warp the spectrum. The warped spectrum is then scaled and compressed and low-order all-pole modeling is performed to estimate the smooth envelope of the modified spectrum. However, although the PLP approach combines the FFT filterbank and LP methods, the spectrum is still obtained from the FFT, and FFT-based signal modeling has certain important disadvantages: First, the capability of the FFT spectrum, without warping, to model peaks of the speech spectral envelope—which are linguistically and perceptually critical—depends on the characteristics of the finer harmonic peaks caused by the opening of the vocal cords (glottis). Thus, the parameters to be analyzed are significantly affected by glottal characteristics, which is clearly undesirable. Second, many processing schemes (such as mel-scale warping, equal-loudness weighting, cubic-root compression, and logarithm computation) when performed on a large number of spectral samples (typical FFT size N=512 for a sampling rate of 16 kHz) require memory, table-lookup, and/or interpolation, which can be computationally inefficient.

The advantages of LP are (1) it produces a smooth spectrum without glottal harmonic aspects, (2) it is relatively less complex and requires less memory than other methods, and (3) it is already implemented in many command-based speech recognition and synthesis systems wherein feedback is provided to the user using speech vocoders. Thus, since LP is used in most vocoder algorithms, significant savings in computation and storage results if the LP-based cepstral features are used for speech recognition. Thus there have been attempts to find ways to warp the LP parameters to achieve better speech recognition. For example, a bilinear transformation and the inverse FFT computation has been used to warp the log-magnitude spectrum of the LP parameters. However, computing the logarithm involves table-lookup and spline interpolation (which gives approximate values), thereby increasing memory and computational requirements. Further, the accuracy of the bilinear transform in approximating the mel scale drops as the sampling frequencies decrease, making it unsuitable for signal sampling below 10 kHz. Still further, the high-frequency region still shows sharp spectral peaks (formants) even after the warping, which is inconsistent with human hearing theory which postulates that the resolution of peaks decreases with increase in frequency. Another example, the time-domain method, does not require FFT but, in addition to the same shortcomings just described, is also just an approximation to an infinite-length solution. In fact, conventional LP-based systems use the LP cepstrum without perceptual warping because the LP warping techniques described immediately above do not achieve a significant increase in recognition accuracy despite the increased complexity.

### SUMMARY OF THE INVENTION

The present invention is an apparatus and method for generating parametric representations of input speech based on a mel-frequency warping of the vocal tract spectrum which is computationally efficient and provides increased recognition accuracy over conventional LP cepstrum approaches. It is capable of rapid processing operable in many different devices. The invention is a speech recognition system comprising linear prediction (LP) signal processor and a mel-frequency linear prediction (MFLP) generator for mel-frequency warping the LP parameters to generate MFLP parametric representations of speech for robust, perceptually modeled speech recognition requiring minimal computation and storage.

### BRIEF DESCRIPTION OF THE DRAWINGS

FIG. 1 is a block diagram of the mel-frequency linear prediction (MFLP) feature extraction speech recognition system according to the present invention.

FIG. 2 is a block diagram of the mel-frequency linear prediction (MFLP) system according to the present invention.

FIG. 3 is a block diagram of a preferred embodiment of the present invention showing the speech signal processing from input to MFLP cepstrum production.

FIG. 4 is a block diagram of an exemplary speech recognition system utilizing the present invention.

FIG. 5 illustrates the system architecture of a cellular phone with an embodiment of the present invention embedded therein.

### DETAILED DESCRIPTION OF THE INVENTION

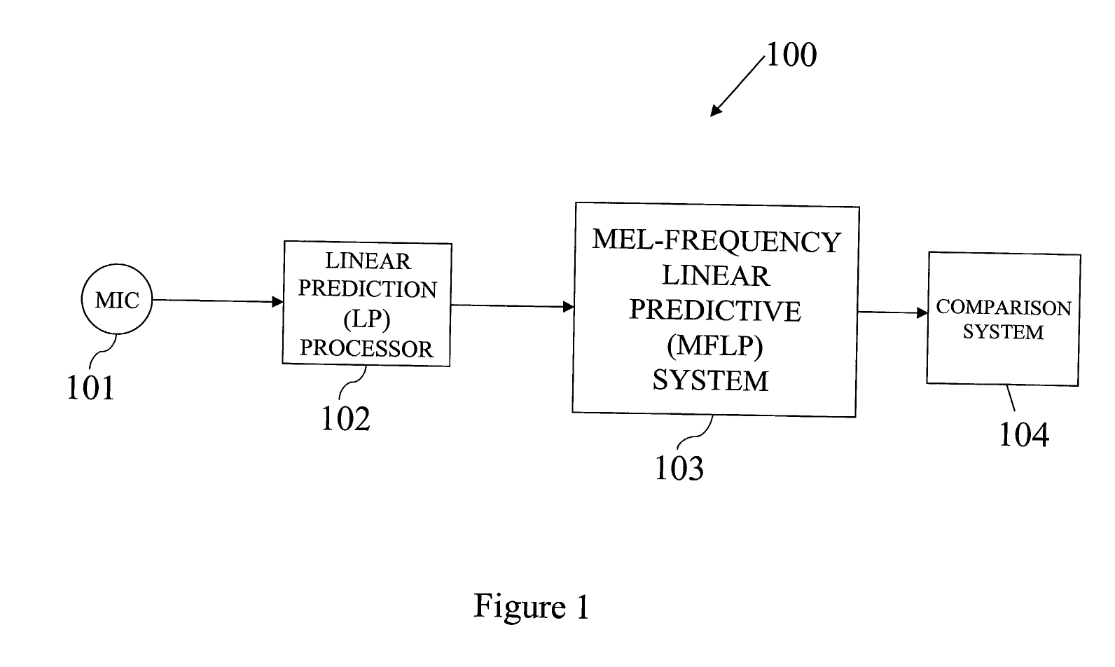

FIG. 1 is a block diagram of the mel-frequency linear prediction feature extraction speech recognition system 100 of the present invention. A microphone 101 receives an audio voice string and converts the voice string into a digital waveform signal. A linear prediction (LP) processor 102 processes the waveform to produce a set of LP coefficients of the speech. LP processor 102 is coupled to a mel-frequency linear prediction (MFLP) feature extraction system 103 according to the present invention. MFLP 103 feeds the extracted features to comparison system 104 for speech recognition by comparison to templates or other reference means. It is understood that any recognition system capable of processing speech spectrum parameters can be advantageously utilized to process the speech features generated by MFLP 103, for example, an MFLP feature extraction system such as MFLP 103 can be also beused as a front-end processor for other speech recognition systems such as those based on hidden Markov models (HMMs) or neural networks

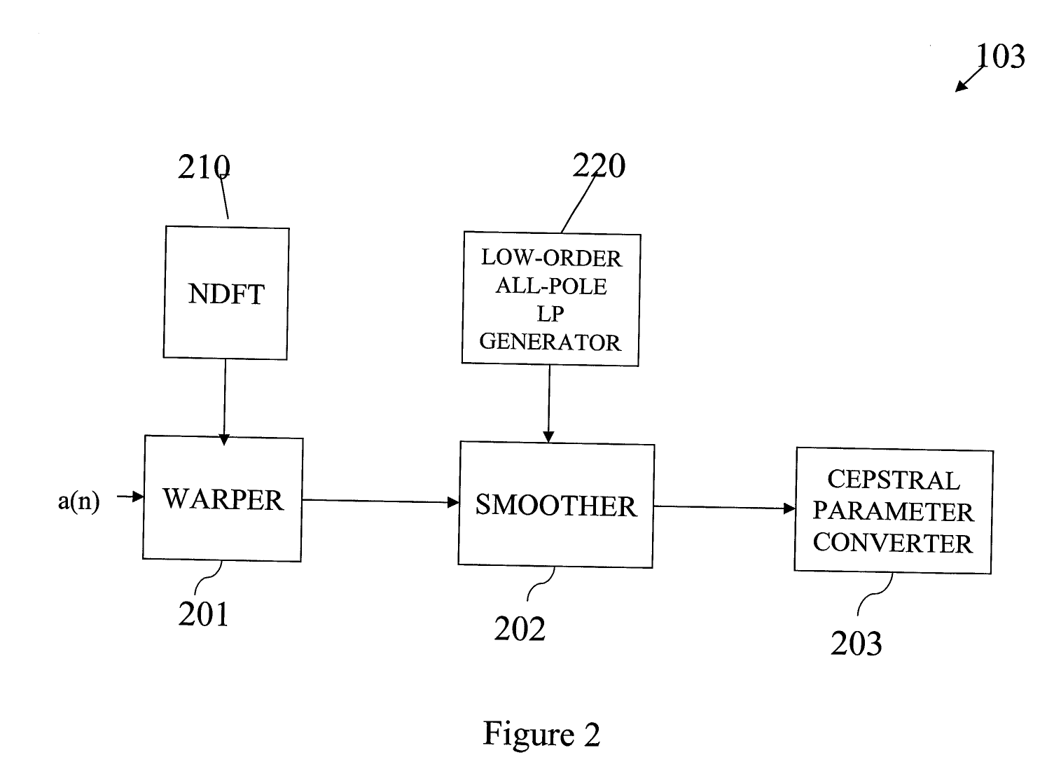

FIG. 2 is a block diagram of the preferred embodiment of the invention MFLP 103. An impulse response function a(n) corresponding to the inverse LP spectrum is transmitted to warper 201 which performs warping by taking the non-uniform discrete Fourier transform (NDFT) of the impulse response corresponding to the inverse of the vocal-tract transfer function. Warper 201 is coupled to a smoother 202 which smoothes the frequency-warped signal utilizing a low-order all-pole LP model generator 220. Cepstral parameter converter 203 is coupled to smoother 202 to receive the smoothed version of the warped LP coefficients to generate cepstral parameters.

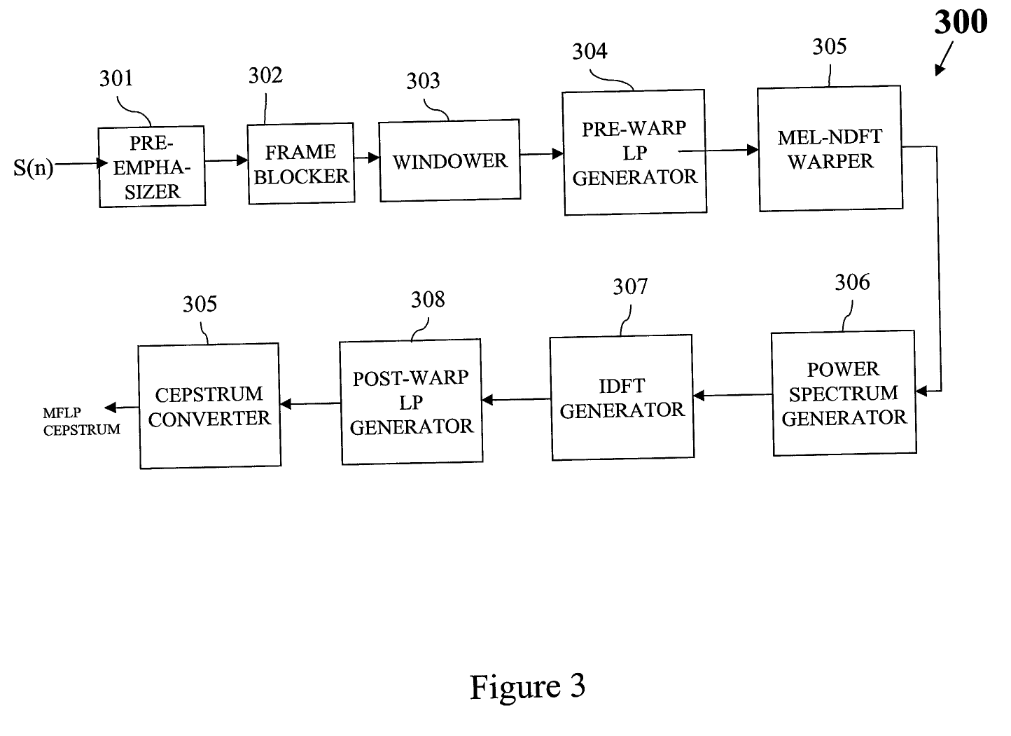

FIG. 3 is a block diagram of a preferred embodiment of the present invention. A pre-emphasizer 301, which preferably is a fixed low-order digital system (typically a first-order FIR filter), spectrally flattens the signal s(n), as described by:

P(z)=1−az⁻¹ (1)

where 0.9 a 1.0. The preferred embodiment utilizes a=0.98 in order to flatten the spectrum and to improve numerical stability in obtaining the LP parameters. Frame blocker 302 frame blocks the speech signal in frames of M samples, with adjacent frames being separated by R samples. There is one feature per frame so that for a one second utterance (50 frames long), 12 parameters represent the frame data, and a 50×12 matrix is generated (the template feature set). This embodiment of the invention utilizes values of M and R such that the blocking is into 32 msec frames. Windower 303 windows each individual frame to minimize the signal discontinuities at the beginning and end of each frame. The preferred embodiment advantageously utilizes a Hamming window. For each frame of the speech signal S(n), pre-warp LP generator 304 performs p^{th}-order LP analysis to generate p predictor coefficients {a₁, a₂, . . . , aₚ}. The vocal-tract transfer function H(z) is

$$H ( z ) = \frac{G}{A ( z )} = \frac{G}{1 - {\sum }_{k = 1}^{p} {a}_{k} {z}^{- k}} \qquad ( 2 )$$

where G is the gain. H(z) is a smooth, all-pole model of the vocal-tract spectrum with all effects of the glottal source removed.

Mel-NDFT warper 305, in the preferred embodiment of the present invention, advantageously utilizes a non-uniform discrete Fourier transform (NDFT) to warp the vocal-tract transfer function on the mel scale. Taking the discrete-time Fourier transform (DTFT) of the finite impulse response of the inverse LP system a(n)=[1, −a₁, −a₂, . . . , −aₚ,] gives A(eⁱ) where is the linear frequency in rad/samples. Taking N samples of A(eⁱ) using a non-uniform grid \tilde{ω}={ωₖ}, where k=0, 1, . . . , N, the NDFT for a(n) is

$$\tilde{A} ( k ) \approx {\sum }_{n = 0}^{p} a ( n ) {e}^{- j {ω}_{k} n}$$

where k=0, 1, . . . , N−1 and the ₖ are the non-uniform samples between [0, 2] that resemble the mel frequency scale. The warped grid \tilde{ω}={ωₖ}=2πfₖ|fₛ, where fₛis the sampling frequency, is obtained by oversampling the mel filterbank. From 0 to 1000 Hz, the region is sampled linearly, with Nₗ. being the number of samples, as follows:

$${f}_{k} = k \cdot \frac{1000}{{N}_{l}} H z$$

where k=0, 1, . . . , Nₗ. Frequency samples in the octaves beyond 1000 Hz (1000-2000 Hz, 2000-4000 Hz, and so on) are placed so that they are equally spaced in the log domain according to

fₖ₌ₖ_{₀}=10^{log}^{₁₀}^{f}^{ₘᵢₙ}^{+kΔ}

where k=0, 1, . . . , Nₘ and

$$\begin{matrix}Δ = \frac{{log}_{10} {f}_{max} - {log}_{10} {f}_{min}}{{N}_{m}} \\ = \frac{{log}_{10} 2 {f}_{min} - {log}_{10} {f}_{min}}{{N}_{m}} \\ = \frac{{log}_{10} 2}{{N}_{m}}\end{matrix}$$

where Nₘ is the number of samples per octave beyond 1000 Hz, and

k₀=Nₗ+(K−1)Nₘ

where K is the number of octaves from 1000 to the Nyquist frequency fₛ/2. Here fₘₐₓ=2fₘᵢₙ and the value of fₘᵢₙ is only defined for octaves 1000 Hz; that is, fₘᵢₙ=2^{l} 1000, where l is an integer. The NDFT size (total number of spectral samples) is

N=2(Nₗ+KNₘ).

In an embodiment of the present invention, Nₗ=20 and Nₘ=10 so that for a sampling rate of fₛ=8 kHz, the NDFT size N is 2×(20+2×10)=80. Table 1 shows the values of the mel-warped frequency grid for Nyquist frequencies up to 8000 Hz (at a sampling rate of 16 kHz). Higher sampling rates are of course within the contemplation of the present invention.

After mel-NDFT warper 305 generates the mel-warped signal, power spectrum generator 306 generates the warped vocal-tract power spectrum \tilde{P}(k) which is obtained from Ã(k) by using

$$\tilde{P} ( k ) = \frac{{G}^{2}}{\vert \tilde{A} ( k ) {\vert}^{2}}$$

where k=0, 1, . . . , N−1.

The warped vocal-tract power spectrum \tilde{P}(k) is modeled utilizing the theory of spectral reduction in human hearing. The theory postulates that humans attempt to simplify the structure of the speech spectrum in perceiving vowels and that a two-peak model simulation is sufficient for discriminating vowels (cf. R. Carlson et al. Auditory Analysis and Perception of Speech, 55-82, Academic, N.Y.). Inverse discrete Fourier transform (IDFT) generator 307 models \tilde{P}(k) using a small number of peaks. Further, since the warping compresses high-frequency peaks, they tend to merge and form a single peak in the LP modeling process, thereby emulating the non-uniform nature of peak resolution by the human auditory system. IDFT generator 307 computes the inverse DFT of the warped power spectrum \tilde{P}(k) generating r+1 samples of the warped autocorrelation sequence

$$\tilde{R} ( n ) = \frac{1}{N} {\sum }_{k = 0}^{N - 1} \tilde{P} ( k ) {e}^{j 2 π k n / N}$$

where r=6 and n=0, 1, . . . , r. Post-warp LP generator 308 then performs a linear prediction of order r using \tilde{R}(n) to generate a new set of LP parameters {ã(n)}, where n=1, . . . , r. These parameters are different from the original LP parameters {a(n)} in that they model the warped LP spectrum instead of the original spectrum. Cepstrum converter 309 converts the new LP parameters {ã(n)} to cepstral coefficients utilizing the recursion relation

c(0)=ln G

$$c ( n ) = ã ( n ) + \frac{1}{n} {\sum }_{k = 1}^{n - 1} kc ( k ) ã ( n - k )$$

for n>0. The result is the MFLP cepstrum according to the present invention. It is understood by those in the art that the speech analysis parameters, including the pre-emphasis parameter, window length, hop size, pr-warp LP order, NDFT length, post-warp order, and feature size, may be tuned to various conditions (for example the sampling rate, the computation and storage requirements).

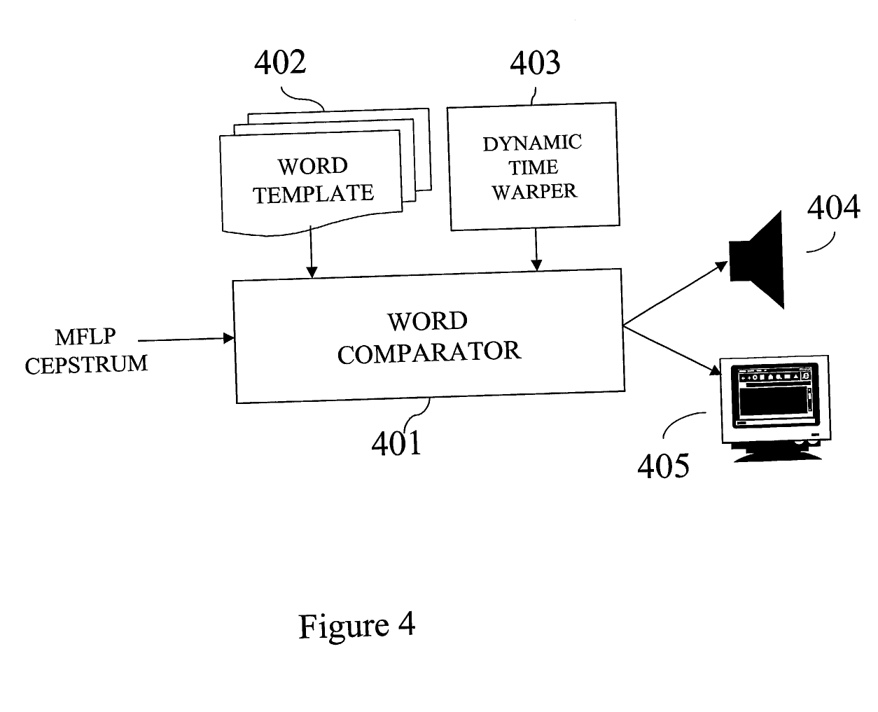

FIG. 4 is a block diagram of an exemplary speech recognition system utilizing the present invention. The parametric representation of the speech utilizing the MFLP cepstrum is inputted into word comparator 401. The speech is compared with the cepstral coefficient parametric representations of word pronunciations in word template 407, by comparing cepstral distances. Dynamic time warper (DTW) 408 performs the dynamic behavior analysis of the spectra to more accurately determine the dissimilarity between the inputted speech and the matched speech spectra from word template 402. DTW 408 time-aligns and normalizes the speaking rate fluctuation by finding the “best” path through a grid mapping the acoustic features of the two patterns to be compared. The result is the speech recognition which can be confirmed acoustically by speaker 404 or displayed on display 405.

Experimental results confirm the effectiveness of the present invention when compared with conventional LP signal processing. A name recognition experiment was conducted involving 24 names uttered by 8 speakers (4 male, 4 female), wherein the names were specifically chosen as having high likelihoods of confusion; for example, “Mickey Mouse”, “Minnie Mouse”, and “Minnie Driver”. Three experiments were performed in an office environment using a head-mounted microphone. The speech signal was sampled at 8 kHz with 16 bit PCM encoding. Each speaker uttered the name three times, and two of the three utterances were used as the templates for recognition based on dynamic time warping. The template and input patterns were swapped each experiment and the average taken as the final result. Table 2 lists the average recognition accuracy for each speaker for the LP and the MFLP of the present invention. The results show higher recognition accuracy for every case and is particularly pronounced for B female speaker.

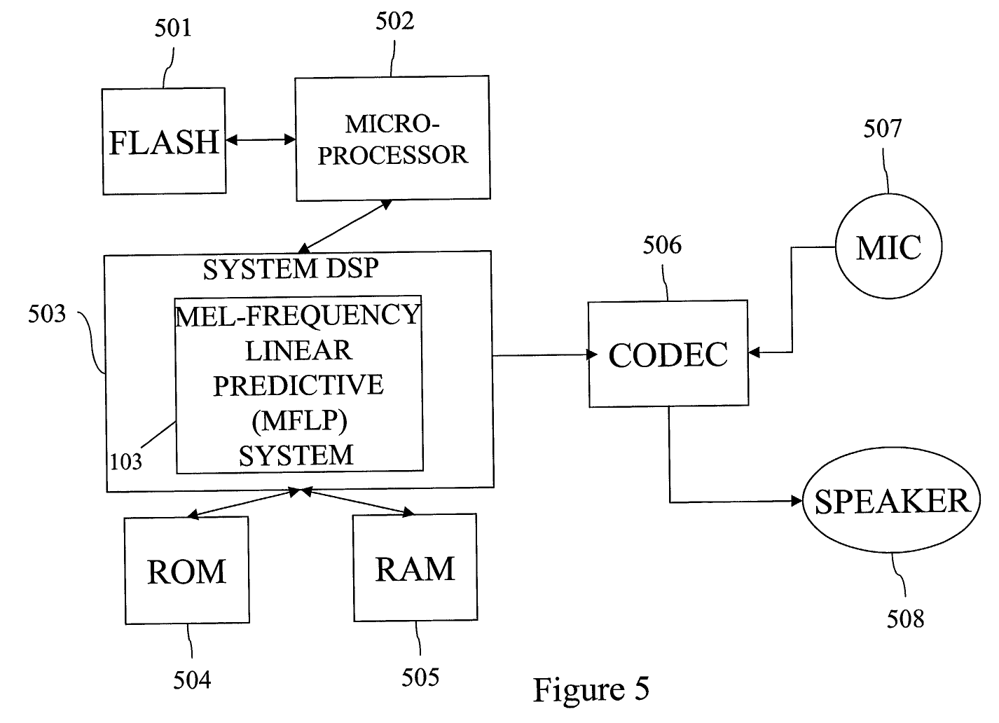

The preferred embodiment of the present invention, because it utilizes LP parameters which are available in most compact speech coding systems, allows simple integration into existing operating systems with a huge reduction of storage. Some of the examples are Microsoft Windows CE® for PDAs and ARM7TDMI for cell phones, and consumer electronic devices. By utilizing existing LP systems, the present invention obviates extensive redesign and reprogramming. An embodiment of the present invention's speech recognition programs also may be loaded into the flash memory of a device such as a cell phone or PDA, thus allowing easy, quick, and inexpensive integration of the present invention into existing electronic devices, avoiding the redesign or reprogramming of the DSP of the host device. Further, the speech recognition programs may be loaded into the memory by the end-user through a data port coupled to the flash memory. This can be accomplished also through a download from the Internet. FIG. 5 illustrates the system architecture of a cellular phone with an embodiment of the present invention embedded therein. In the preferred embodiment of the present invention, for cellular phones which use LP, the vocoder parameters can be directly decoded to produce LP parameters, which are then transmitted to MFLP system 103, thereby eliminating the need for LP processor 102 (in FIG. 1). Flash memory 501 is coupled to microprocessor 502 which in turn is coupled to DSP processor 503, which in conjunction with flash memory 501 and microprocessor 502, performs the MFLP speech recognition described above. Read-Only-Memory (ROM) device 504 and Random Access Memory (RAM) device 505 service DSP processor 503 by providing memory storage for templates 402 (FIG. 4). Speech input through microphone 507 is coded by coder/decoder (CODEC) 506. After speech recognition by DSP processor 503, the speech signal is decoded by CODEC 506 and transmitted to speaker 508 for audio confirmation. Alternatively, speaker 508 can be a visual display.

While the above is a full description of the specific embodiments, various modifications, alternative constructions and equivalents may be used. For example, the MFLP feature extraction system of the present invention can be used as a front-end processor for other speech recognition systems, such as those based on hidden Markav models (HMM) or neural networks. Therefore, the above description and illustrations should not be taken as limiting the scope of the present invention which is defined by the appended claims.

TABLE 1

| | Mel Frequency | | Mel Frequency |
|---|---|---|---|
| Frequency Index | (in Hz) | Frequency Index | (in Hz) |
| 0 | 0 | 26 | 1516 |
| 1 | 50 | 27 | 1625 |
| 2 | 100 | 28 | 1741 |
| 3 | 150 | 29 | 1866 |
| 4 | 200 | 30 | 2000 |
| 5 | 250 | 31 | 2144 |
| 6 | 300 | 32 | 2297 |
| 7 | 350 | 33 | 2462 |
| 8 | 400 | 34 | 2639 |
| 9 | 450 | 35 | 2828 |
| 10 | 500 | 36 | 3031 |
| 11 | 550 | 37 | 3249 |
| 12 | 600 | 38 | 3482 |
| 13 | 650 | 39 | 3732 |
| 14 | 700 | 40 | 4000 |
| 15 | 750 | 41 | 4287 |
| 16 | 800 | 42 | 4595 |
| 17 | 850 | 43 | 4925 |
| 18 | 900 | 44 | 5278 |
| 19 | 950 | 45 | 5657 |
| 20 | 1000 | 46 | 6063 |
| 21 | 1071 | 47 | 6498 |
| 22 | 1149 | 48 | 6964 |
| 23 | 1231 | 49 | 7464 |
| 24 | 1320 | 50 | 8000 |
| 25 | 1414 | | |

TABLE 2

| Speaker | LP Cepstrum | MFLP Cepstrum |
|---|---|---|
| A (female) | 90.28 | 94.44 |
| B (female) | 73.61 | 91.67 |
| C (female) | 95.83 | 98.61 |
| D (female) | 98.61 | 98.61 |
| E (male) | 100.00 | 100.00 |
| F (male) | 94.44 | 94.44 |
| G (male) | 100.00 | 100.00 |
| H (male) | 100.00 | 100.00 |
| Overall Accuracy | 94.10 | 197.22 |

What is claimed is:

1. A speech recognition system comprising:
microphone means for receiving acoustic waves and converting the acoustic waves into electronic signals;
linear prediction (LP) signal processing means, coupled to said microphone means, for processing the electronic signals to generate LP parametric representations of the electronic signals;
mel-frequency linear prediction (MFLP) generating means, coupled to said LP signal processing means, for mel-frequency warping said LP parametric representations to generate MFLP parametric representations of the electronic signals; and
word comparison means coupled to said MFLP means, for comparing said MFLP parametric representations of the electronic signals to parametric representation of words in a database.

2. The speech recognition system of claim 1 wherein said mel-frequency linear prediction (MFLP) generating means comprises:
non-uniform discrete Fourier transform (NDFT) generator means for generating the NDFT of said LP parametric representations of the electronic signals;
warper means, coupled to said NDFT generator means, for mel-frequency warping said NDFT;
smoothing means, coupled to said warper means, for smoothing said mel-frequency warped NDFT; and
cepstral parameter converter means, coupled to said smoothing means, for converting said LP parametric representations of the electronic signals to cepstral parameters.

3. The speech recognition system of claim 2 wherein said smoothing means utilizes a low-order all-pole LP generator.

4. The speech recognition system of claim 1 wherein said word comparison means is a dynamic time warper speech recognition system.

5. The speech recognition system of claim 1 wherein said word comparison means is a hidden Markov model speech recognition system.

6. The speech recognition system of claim 1 wherein said word comparison means is a neural network speech recognition system.

7. A speech recognition system for recognizing a speech signal, comprising:
a pre-emphasizer for spectrally flattening the speech signal;
a frame blocker, coupled to said pre-emphasizer, for frame blocking the speech signal;
a windower, coupled to said frame blocker, for windowing each blocked frame;
a pre-warp LP generator, coupled to said windower, to generating a plurality of pre-warp LP parameters;
a mel-NDFT warper, coupled to said pre-warp LP generator, for utilizing a non-uniform discrete Fourier transform (NDFT) to warp said pre-warp LP parameters on a mel scale to generate a plurality of mel scale-warped LP parameters;
a power spectrum generator, coupled to said mel-NDFT warper, for generating a warped vocal-tract power spectrum from said mel scale-warped LP parameters;
an IDFT generator, coupled to said power spectrum generator, for generating an inverse discrete Fourier transform of the warped vocal-tract power spectrum;
a post-warp LP generator, coupled to said IDFT generator, for generating a plurality of post-warp LP parameters; and
a cepstrum converter, coupled to said post-warp LP generator, for converting said post-warp LP parameters to a plurality of MFLP cepstral coefficients.

8. The speech recognition system of claim 7 wherein said pre-emphasizer is a fixed low-order digital filter.

9. The speech recognition system of claim 7 wherein said windower is a Hamming window.

10. The speech recognition system of claim 7 wherein said warped vocal-tract power spectrum is modeled utilizing a predetermined number of peaks.

11. The speech recognition system of claim 7 further comprising:
a word template for storing a plurality of cepstral coefficient parametric representations of word pronunciations;
a dynamic time warper for dynamic behavior analysis of said MFLP cepstral coefficients; and
a word comparator, coupled to said cepstrum converter, to said word template, and to said dynamic time warper, for comparing said plurality of MFLP cepstral coefficients with said plurality of cepstral coefficient parametric representations of word pronunciations;

12. A mobile communication device comprising:
a flash memory;
a microprocessor, coupled to said flash memory,
a DSP processor, coupled to said flash memory and said microprocessor, and responsive to said flash memory and said microprocessor, for performing mel-frequency linear prediction (MFLP) speech recognition;
a read-only-memory (ROM) device, coupled to said DSP processor, for storage of data; and
a random access memory (RAM) device 505, for storage of data.

13. A method for modifying the linear prediction (LP) vocal-tract spectrum comprising the steps of:
(a) mel-frequency warping the LP vocal-tract spectrum to generate a mel-frequency warped LP vocal-tract spectrum;
(b) modeling said mel-frequency warped LP vocal-tract spectrum utilizing a predetermined number of peaks; and
(c) performing linear prediction on said modeled mel-frequency warped LP vocal-tract spectrum to generate an LP mel-frequency warped LP vocal-tract spectrum.

14. The method of claim 13 wherein step (a) comprises the steps of:
(a) calculating the discrete-time Fourier transform (DTFT) of the finite impulse response LP parameters;
(b) taking a predetermined number of samples of said DTFT of the finite impulse response LP parameters;
(c) utilizing a non-uniform grid for said DTFT of the LP vocal-tract spectrum to generate a non-uniform discrete Fourier transform (NDFT); and
(d) oversampling a mel filterbank to generate a warped grid for said NDFT of the finite impulse response LP parameters.

15. The method of claim 13 wherein said non-uniform grid of step (c) is substantially similar to the mel frequency scale.

16. The method of claim 14 wherein said oversampling of step (d) is linear from 0 to 1000 Hz and frequency samples in the octaves greater than 1000 Hz are sampled at equal spaces in the log domain.

17. The method of claim 13 wherein said predetermined number of peaks in step (b) is two.

18. The method of claim 13 wherein said step (c) comprises the steps of:
computing the inverse discrete Fourier transform (DFT) said modeled mel-frequency warped LP vocal-tract spectrum;
generating a predetermined number of samples of an autocorrelation sequence of said modeled mel-frequency warped LP vocal-tract spectrum; and
performing linear prediction to generate a plurality of LP parameters from said modeled mel-frequency warped LP vocal-tract spectrum.

19. A method for processing speech acoustic signals, comprising the steps of:
(a) receiving the speech acoustic waves utilizing a microphone;
(b) converting the speech acoustic waves into electronic signals;
(c) parameterizing the electronic signals utilizing linear prediction (LP);
(d) mel-frequency warping said linear prediction parametric representations; and
(e) comparing said mel-frequency warped linear prediction parametric representation with parametric representations of words in a database.
